(19) United States
(12) Patent Application Publication
(10) Pub. No.: US 2024/0260123 A1
(43) Pub. Date: Aug. 1, 2024

(54) WIRELESS COMMUNICATION DEVICE, WIRELESS COMMUNICATION SYSTEM, AND WIRELESS COMMUNICATION METHOD

(71) Applicant: FUJITSU LIMITED, Kawasaki-shi Kanagawa (JP)

(72) Inventors: Yoshiaki OHTA, Yokohama (JP); Shinichiro AIKAWA, Yokohama (JP); Yoshihiro KAWASAKI, Kawasaki (JP)

(73) Assignee: FUJITSU LIMITED, Kawasaki-shi Kanagawa (JP)

(21) Appl. No.: 18/626,713

(22) Filed: Apr. 4, 2024

Related U.S. Application Data
(63) Continuation of application No. PCT/JP2021/038591, filed on Oct. 19, 2021.

(51) Int. Cl. H04W 76/27

(52) U.S. Cl. CPC H04W 76/27

(57) ABSTRACT

A wireless communication device includes processor circuitry configured to control, in a case of performing communication with another wireless communication device, so as to perform data communication using simultaneously a plurality of cell groups including a cell being able to control a control plane and another cell that are selected when the communication with the other wireless communication device in a non-communication mode is established.

### CROSS-REFERENCE TO RELATED APPLICATION

This application is a continuation of International Application No. PCT/JP2021/038591, filed on Oct. 19, 2021, the entire contents of which are incorporated herein by reference.

### FIELD

The embodiments discussed herein are related to a wireless communication device, a wireless communication system, and a wireless communication method.

### BACKGROUND

In general, a process of a radio resource control (RRC) layer is performed in wireless communication systems. In the process of the RRC layer, for example, connection configuration, modification, release, and the like are performed between a base station device and a terminal device. For example, in Long Term Evolution (LTE) or LTE-Advanced (LTE-A), which is the standard technology for 4G, an RRC connected mode (RRC_CONNECTED) and an RRC Idle mode (RRC_IDLE) are defined as the states of the RRC layer. The RRC connected mode, for example, is a mode in which data communication can be performed between a base station device and a terminal device. The RRC idle mode is, for example, a mode in which data communication is not performed between the base station device and the terminal device, and in which the terminal device is in a power-saving state.

In 5th generation mobile communication (5G or New Radio (NR)), an RRC inactive mode (RRC_INACTIVE) is introduced in addition to the RRC connected mode and the RRC idle mode. The RRC inactive mode is a low-power consumption mode equivalent to the RRC idle mode, which allows a quick transition to the RRC connected mode at data transmission. In the RRC inactive mode, the context of the terminal device (hereinafter “UE context”) is held in the base station device. The UE context is identification information that identifies information about the terminal device, such as location, communication capability, and various parameters of the terminal device. Thus, since the UE context is held in the base station device, even in the RRC inactive mode, the terminal device is considered as being connected to the base station device by the core network. As a result, when the terminal device returns from the RRC inactive mode to the RRC connected mode, signal transmission and reception between the base station device and the core network are omitted, resulting in a quick transition to the RRC connected mode.

The terminal device measures the reference signal received power (RSRP) from the surrounding base station devices in the non-communication modes such as the RRC idle mode and the RRC inactive mode, and selects and camps on the cell of the base station device with the highest RSRP. Then, when the terminal device returns to the communication mode such as the RRC connected mode and starts communication, the terminal device performs wireless communication using the camped-on cell. The related technologies are described, for example, in: International Publication Pamphlet No. WO 2019/065814, 3GPP TS36.133 V17.1.0 (2021 March), 3GPP TS36.211 V16.5.0 (2021 March), 3GPP TS36.212 V16.5.0 (2021 March), 3GPP TS36.213 V16.5.0 (2021 March), 3GPP TS36.214 V16.2.0 (2021 March), 3GPP TS36.300 V16.5.0 (2021 March), 3GPP TS36.321 V16.4.0 (2021 March), 3GPP TS36.322 V16.0.0 (2020 July), 3GPP TS36.323 V16.3.0 (2020 December), 3GPP TS36.331 V16.4.0 (2021 March), 3GPP TS36.413 V16.5.0 (2021 April), 3GPP TS36.423 V16.5.0 (2021 April), 3GPP TS36.425 V16.0.0 (2020 July), 3GPP TS37.324 V16.2.0 (2020 September), 3GPP TS37.340 V16.5.0 (2021 March), 3GPP TS38.201 V16.0.0 (2019 December), 3GPP TS38.202 V16.2.0 (2020 September), 3GPP TS38.211 V16.5.0 (2021 March), 3GPP TS38.212 V16.5.0 (2021 March), 3GPP TS38.213 V16.5.0 (2021 March), 3GPP TS38.214 V16.5.0 (2021 March), 3GPP TS38.215 V16.4.0 (2020 December), 3GPP TS38.300 V16.5.0 (2021 March), 3GPP TS38.321 V16.4.0 (2021 March), 3GPP TS38.322 V16.2.0 (2020 December), 3GPP TS38.323 V16.3.0 (2021 March), 3GPP TS38.331 V16.4.1 (2021 March), 3GPP TS38.401 V16.5.0 (2021 April), 3GPP TS38.410 V16.3.0 (2020 September), 3GPP TS38.413 V16.5.0 (2021 April), 3GPP TS38.420 V16.0.0 (2020 July), 3GPP TS38.423 V16.5.0 (2021 April), 3GPP TS38.470 V16.4.0 (2021 April), 3GPP TS38.473 V16.5.0 (2021 April), 3GPP TR38.801 V14.0.0 (2017 March), 3GPP TR38.802 V14.2.0 (2017 September), 3GPP TR38.803 V14.2.0 (2017 September), 3GPP TR38.804 V14.0.0 (2017 March), 3GPP TR38.900 V15.0.0 (2018 June), 3GPP TR38.912 V16.0.0 (2020 July), and 3GPP TR38.913 V16.0.0 (2020 July).

By the way, some wireless communications performed by terminal devices use a plurality of carriers, such as dual connectivity (DC) and carrier aggregation (CA). When a terminal device that returns to the communication mode performs wireless communication using the carriers, the terminal device measures the RSRP from the surrounding base station devices after returning to the communication mode and reports the measurement results in the cell that is camped on in the non-communication mode. Upon receiving the report, the base station device determines the cell (or carrier) to be used for DC or CA on the basis of the measurement result and configures the terminal device to perform DC or CA.

### SUMMARY

According to an aspect of an embodiment, a wireless communication device includes a processor configured to control, in a case of performing communication with another wireless communication device, so as to perform data communication using simultaneously a plurality of cell groups including a cell being able to control a control plane and another cell that are selected when the communication with the other wireless communication device in a non-communication mode is established.

The object and advantages of the disclosure will be realized and attained by means of the elements and combinations particularly pointed out in the claims.

It is to be understood that both the foregoing general description and the following detailed description are exemplary and explanatory and are not restrictive of the disclosure, as claimed.

### BRIEF DESCRIPTION OF DRAWINGS

FIG. 1 is a diagram illustrating a structure example of a wireless communication system according to a first embodiment;

FIG. 2 is a block diagram illustrating a structure of a base station device;

FIG. 3 is a block diagram illustrating a structure of a terminal device;

FIG. 4 is a sequence diagram illustrating a cell selecting method according to a second embodiment;

FIG. 5 is a sequence diagram illustrating the operation at communication mode transition;

FIG. 6 is a sequence diagram illustrating a cell selecting method according to a third embodiment;

FIG. 7 is a sequence diagram illustrating a cell selecting method according to another embodiment; and

FIG. 8 is a sequence diagram illustrating the operation at communication mode transition according to another embodiment.

### DESCRIPTION OF EMBODIMENTS

However, the communication using the carriers as described above has the problem that there is delay before the start. In other words, the terminal device transits from the non-communication mode to the communication mode in the first stage, and then performs measurements related to the radio and adds the cell (or carrier) in the second stage, thereby starting the communication by DC or CA. This makes it difficult to start DC or CA immediately after transiting to the communication mode, resulting in communication delay. Such delay at the start of communication, for example, adversely affects the throughput of the Transmission Control Protocol/Internet Protocol (TCP/IP).

Preferred embodiments of the present disclosure will be explained with reference to accompanying drawings. The present disclosure is not limited by the embodiments below.

### a. First Embodiment

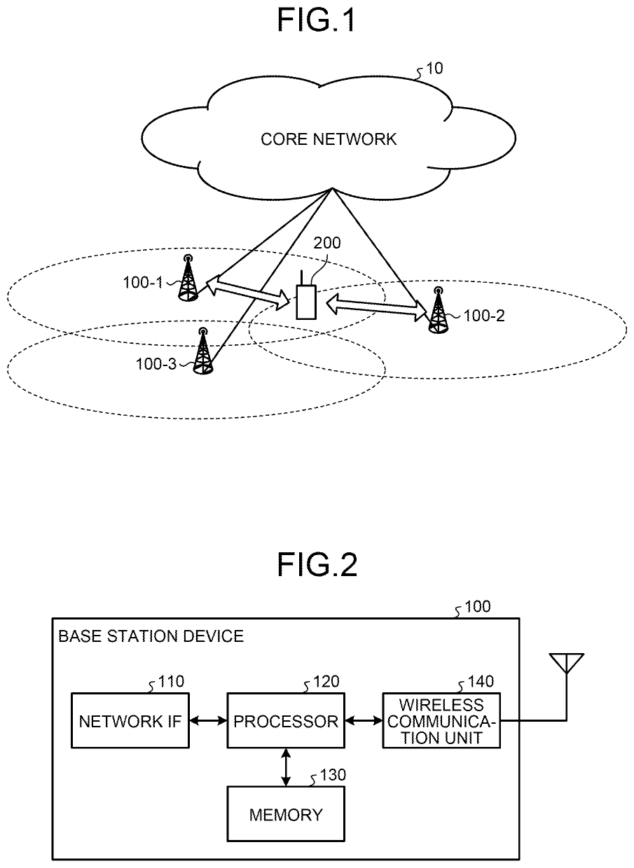

FIG. 1 is a diagram illustrating a structure example of a wireless communication system according to a first embodiment. The wireless communication system illustrated in FIG. 1 includes a plurality of base station devices 100-1 to 100-3 connected to a core network 10, and a terminal device 200.

Each of the base station devices 100-1 to 100-3 is a wireless communication device that is connected to the core network 10 and can communicate wirelessly with the terminal device 200 located in the cell. Although the illustration is omitted, the base station devices 100-1 to 100-3 are connected to each other by, for example, X2 interface or Xn interface. In FIG. 1, the cells formed by the base station devices 100-1 to 100-3 are indicated by dashed lines.

Each of the base station devices 100-1 to 100-3 includes a control unit. In a case of performing communication with the terminal device 200, the control unit can control so as to perform data communication using simultaneously a plurality of cell groups including a cell that can control a control plane (C-plane) and another cell selected when the communication with the terminal device 200 in the non-communication mode is established. In other words, any one of the base station devices 100-1 to 100-3 becomes a primary base station that forms a primary cell, which is a cell that can control the C-plane, and at least another one of the base station devices 100-1 to 100-3 becomes a secondary base station that forms a secondary cell, which is a cell that transmits and receives data of a user plane (U-plane).

These base station devices 100-1 to 100-3 are selected as the primary base station to be primary access or the secondary base station to be secondary access when the terminal device 200 in the non-communication mode establishes communication. In other words, the primary base station and the secondary base station are selected from the base station devices 100-1 to 100-3 while the terminal device 200 is in the non-communication mode. Therefore, when the terminal device 200 transits from the non-communication mode to the communication mode, the base station devices 100-1 to 100-3 can immediately start the communication by DC, for example, as the primary base station and the secondary base station.

The terminal device 200 is a wireless communication device that, when located in a cell, can communicate wirelessly with the base station devices 100-1 to 100-3 forming that cell. The terminal device 200 can operate while switching between the communication mode, such as the RRC connected mode, and the non-communication modes, such as the RRC inactive mode, for example.

The terminal device 200 includes a control unit. In a case of transiting to the communication mode and performing communication with the base station devices 100-1 to 100-3, the control unit can control so as to perform data communication using simultaneously a plurality of cell groups including a cell that can control a C-plane and another cell selected when the communication with the base station devices 100-1 to 100-3 is established in the non-communication mode under the control from the communication counterpart of the base station devices 100-1 to 100-3. In other words, the terminal device 200 performs the data communication with the primary base station and the secondary base station among the base station devices 100-1 to 100-3.

The terminal device 200 is configured in advance regarding the primary base station and the secondary base station selected from the base station devices 100-1 to 100-3 in the non-communication mode. Therefore, as soon as the terminal device 200 transits from the non-communication mode to the communication mode, the communication with the primary base station and the secondary base station, for example, by DC can be started.

As described above, according to this embodiment, when the terminal device transits to the communication mode and performs the communication with the base station device, the communication with the primary base station and the secondary base station that are selected in the non-communication mode is started. This can suppress the delay in communication that uses a plurality of carriers.

### b. Second Embodiment

In a second embodiment, call setup is performed with the primary base station and the secondary base station while the terminal device is in the non-communication mode. The structure of the wireless communication system in the second embodiment is similar to that of the first embodiment (FIG. 1); thus, the description thereof is omitted.

FIG. 2 is a block diagram illustrating a structure of the base station device 100 according to the second embodiment. The base station device 100 has a structure equivalent to that of the base station devices 100-1 to 100-3. The base station device 100 illustrated in FIG. 2 includes a network interface (hereinafter abbreviated as “network IF”) 110, a processor 120, a memory 130, and a wireless communication unit 140.

The network IF 110 is connected to the core network 10 with a wire and transmits and receives signals to and from devices included in the core network 10, such as an access and mobility management function (AMF). The network IF 110 has an interface to connect to other base station devices, such as X2 interface, and transmits and receives signals to and from other base station devices.

The processor 120 is a control unit that includes, for example, a central processing unit (CPU), a field programmable gate array (FPGA), or a digital signal processor (DSP), and that collectively controls the entire base station device 100. In addition, the processor 120 controls so as to perform data communication using simultaneously a cell group selected while the terminal device 200 is in the non-communication mode and including the primary cell capable of controlling the C-plane and another secondary cell when the communication with the terminal device 200 in the non-communication mode such as the RRC inactive mode is established. In other words, when the base station device 100 is selected as the primary base station, the processor 120 acquires the identification information of the secondary base station from the terminal device 200 and controls to perform DC by the base station device 100 and the secondary base station. When the base station device 100 is selected as the secondary base station, the processor 120 controls to perform DC by the primary base station and the base station device 100 in accordance with the control by the primary base station.

The memory 130 includes, for example, a random access memory (RAM) or a read only memory (ROM) and stores information used for processing by the processor 120 therein.

The wireless communication unit 140 performs wireless communication with the counterpart terminal device 200. The wireless communication unit 140 transmits the UE context generated by the processor 120, for example, to the terminal device 200. The wireless communication unit 140 then receives the data transmitted from the terminal device 200. Even when the counterpart terminal device 200 is in the non-communication mode, the wireless communication unit 140 can perform predetermined communication with the terminal device 200.

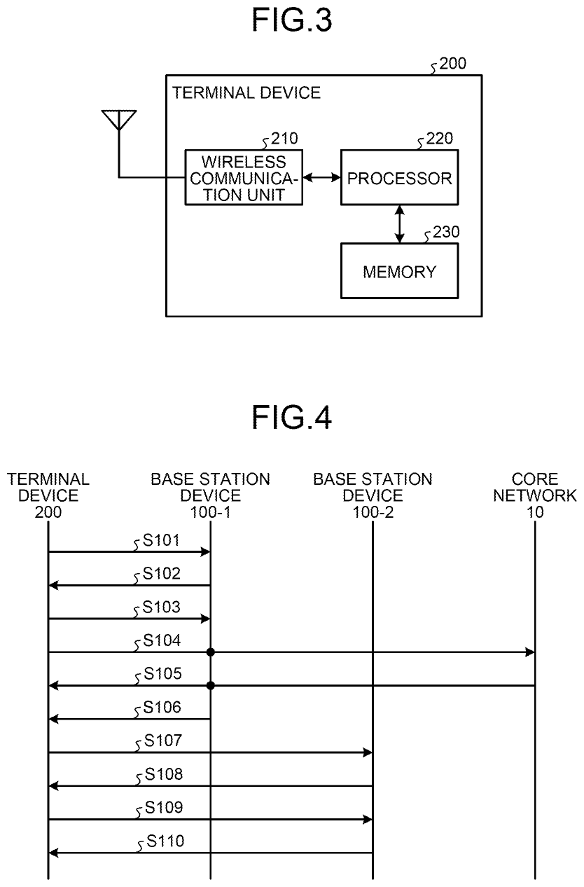

FIG. 3 is a block diagram illustrating a structure of the terminal device 200 according to the second embodiment. The terminal device 200 illustrated in FIG. 3 includes a wireless communication unit 210, a processor 220, and a memory 230.

The wireless communication unit 210 performs wireless communication with the counterpart base station device 100. The wireless communication unit 210 transmits and receives various signals to and from the base station device 100 to switch the communication mode and the non-communication mode of the terminal device 200. For example, the wireless communication unit 210 receives information about the UE context from the base station device 100 when the terminal device 200 establishes the communication with the base station device 100. The wireless communication unit 210 can perform the predetermined communication with the base station device 100 even when the terminal device 200 is in the non-communication mode.

The processor 220 is a control unit that includes, for example, a CPU, an FPGA, or a DSP, and that collectively controls the entire terminal device 200. The processor 220 also switches the mode of the terminal device 200 between, for example, the communication mode, such as the RRC connected mode, and the non-communication mode, such as the RRC inactive mode. In addition, the processor 220 controls so as to perform data communication using simultaneously a cell group selected in the non-communication mode, such as the RRC inactive mode, and including the primary cell capable of controlling the C-plane and another secondary cell. In other words, the processor 120, under the control of the primary base station, executes control to perform DC with the primary base station and the secondary base station selected in the non-communication mode.

The memory 230 includes, for example, a RAM or a ROM and stores information used for the process by the processor 220 therein.

Next, a wireless communication method in the wireless communication system configured as described above will be described with reference to FIG. 4. In the following description, it is assumed that the wireless communication system includes the base station devices 100-1 and 100-2, whose structure is equivalent to that of the base station device 100.

The terminal device 200 measures the RSRP from the surrounding base station devices including the base station devices 100-1 and 100-2 in the non-communication mode and selects the primary base station and the secondary base station. Here, it is assumed that the terminal device 200, for example, selects the base station device 100-1 with the highest RSRP as the primary base station and selects the base station device 100-2 with the RSRP at or above a predetermined threshold as the secondary base station.

Then, the terminal device 200 transmits a message of an access stratum (AS) requesting a connection (hereinafter this message is referred to as “AS message”) in order to establish the communication with the base station device 100-1, which is the primary base station, in the non-communication mode (step S101). Examples of this AS message include an RRC connection request and an RRC connection resume request.

In response to this AS message, an AS message for a predetermined setting is transmitted from the base station device 100-1 to the terminal device 200 (step S102), and an AS message notifying the completion of the connection is transmitted from the terminal device 200 to the base station device 100-1 (step S103). The AS message notifying the completion of the connection can include information indicating that the base station device 100-1 is the primary base station. In other words, the terminal device 200 can notify the base station device 100-1 that the base station device 100-1 is selected as the primary base station. Upon receiving this notification, the base station device 100-1 can grasp that the base station device 100-1 is the primary base station and that a secondary base station will be added. The information indicating that the base station device 100-1 is the primary base station may be included in the AS message requesting the connection at step S101.

Once the connection between the terminal device 200 and the base station device 100-1 is established, a message of a non-access stratum (NAS) for registration (for example, location registration) (hereinafter this message is referred to as a “NAS message”) is transmitted from the terminal device 200 to the core network 10 via the base station device 100-1 (step S104). When the terminal device 200 is registered in the core network 10, a NAS message indicating that the registration has been accepted is transmitted from the core network 10 to the terminal device 200 via the base station device 100-1 (step S105).

In the base station device 100-1, the UE context about the terminal device 200 is generated. Temporary identification information including the identification information of the terminal device 200 and the identification information of the base station device 100-1 is then generated as the identification information of the UE context. This temporary identification information can be, for example, an inactive-radio network temporary identifier (I-RNTI). The I-RNTI is 40-bit identification information that can simultaneously identify the terminal devices and the base station devices. Since the I-RNTI is 40-bit identification information, allocating more bits to the identification information of the base station devices can identify more base station devices but can identify fewer terminal devices. If the number of bits allocated to the identification information of the base station devices is reduced, fewer base station devices can be identified while more terminal devices can be identified. Any information other than I-RNTI that can identify the UE context can be used as the identification information of the UE context.

The generated UE context is held by the base station device 100-1 and the information about the UE context is notified to the terminal device 200, for example, by an AS message to release the connection (step S106). Upon receiving this notification, the terminal device 200 holds the information about the UE context and releases the connection with the base station device 100-1. At this time, the terminal device 200 may transit to the RRC inactive mode, for example.

The terminal device 200 then transmits an AS message requesting a connection in order to establish the communication with the base station device 100-2, which is the secondary base station (step S107). In response to this AS message, an AS message for a predetermined configuration is transmitted from the base station device 100-2 to the terminal device 200 (step S108), and an AS message notifying the completion of the connection is transmitted from the terminal device 200 to the base station device 100-2 (step S109). The AS message notifying the completion of the connection can include the information indicating that the base station device 100-2 is the secondary base station. In other words, the terminal device 200 can notify the base station device 100-2 that the base station device 100-2 is selected as the secondary base station. Upon receiving this notification, the base station device 100-2 can grasp that the base station device 100-2 is the secondary base station. The information indicating that the base station device 100-2 is the secondary base station may be included in the AS message requesting the connection at step S107.

The AS message requesting the connection at step S107 or the AS message notifying the completion of the connection at step S109 can include identification information specifying the base station device 100-1, which is the primary base station. This identification information can be, for example, the information about the UE context that is notified from the base station device 100-1 to the terminal device 200. By being notified of the identification information specifying the primary base station, the base station device 100-2 can specify the primary base station when communicating with the terminal device 200 by DC.

Here, the terminal device 200 has already completed registration with the core network 10 via the base station device 100-1, which is the primary base station. Therefore, when the terminal device 200 has established the connection with the base station device 100-2, the registration with the core network 10 can be omitted. Therefore, the NAS message is not transmitted or received between the terminal device 200 and the core network 10, and the UE context about the terminal device 200 is generated in the base station device 100-2. Then, temporary identification information including the identification information of the terminal device 200 and the identification information of the base station device 100-2 is generated as the identification information of the UE context. This temporary identification information can be, for example, I-RNTI, as well as the identification information generated by the base station device 100-1. Since the I-RNTI is 40-bit identification information, allocating more bits to the identification information of the base station devices can identify more base station devices but can identify fewer terminal devices. If the number of bits allocated to the identification information of the base station devices is reduced, fewer base station devices can be identified while more terminal devices can be identified. Any information other than I-RNTI that can identify the UE context can be used as the identification information of the UE context.

The generated UE context is held by the base station device 100-2 and the information about the UE context is notified to the terminal device 200, for example, by an AS message to release the connection (step S110). Upon receiving this notification, the terminal device 200 holds the information about the UE context and releases the connection with the base station device 100-2. At this time, the terminal device 200 may transit to the RRC inactive mode, for example.

Thus, in the non-communication mode, the terminal device 200 selects the primary base station and the secondary base station according to the RSRP, requests a connection from each of the primary base station and the secondary base station, and receives notification about the UE context from each of the primary base station and the secondary base station. Therefore, when the terminal device 200 returns to the communication mode, the communication by DC with the primary base station and the secondary base station can be immediately performed.

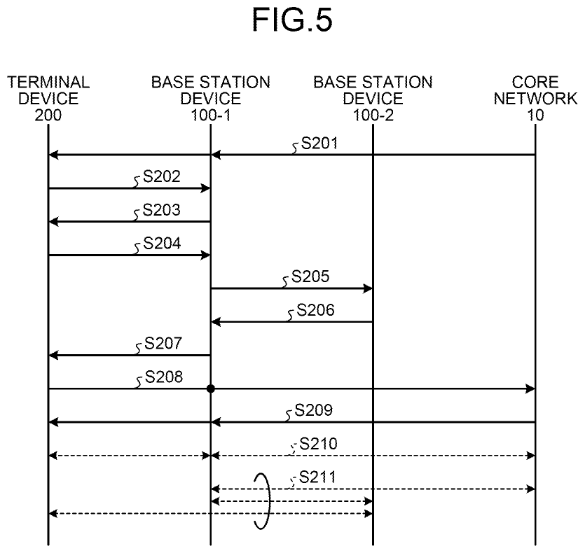

FIG. 5 is a sequence diagram expressing the operation of the wireless communication system when the terminal device 200 transits from the non-communication mode to the communication mode.

For example, when downlink data addressed to the terminal device 200 is generated, paging is performed to call the terminal device 200 from the core network 10 via the base station device 100-1, which is the primary base station (step S201). Upon receiving paging, the terminal device 200 transmits an AS message requesting the connection to the base station device 100-1 in order to return to the communication mode (step S202). This AS message is, for example, an RRC connection resume request (Connection Resume Request).

In response to this AS message, an AS message for a predetermined setting is transmitted from the base station device 100-1 to the terminal device 200 (step S203), and an AS message notifying the completion of the connection is transmitted from the terminal device 200 to the base station device 100-1 (step S204). The AS message notifying the completion of the connection can include identification information specifying the base station device 100-2, which is the secondary base station. This identification information can be, for example, the information about the UE context that is notified from the base station device 100-2 to the terminal device 200.

When the base station device 100-1 is notified of the identification information specifying the base station device 100-2, which is the secondary base station, the base station device 100-2 can be notified that the communication by DC with the terminal device 200 is performed (step S205). The base station device 100-2 has grasped that the base station device 100-2 is the secondary base station and has specified the base station device 100-1, which is the base station to be the primary access. Therefore, the base station device 100-2 replies a message to the base station device 100-1, saying that performing the communication by DC has been confirmed (step S206). The base station device 100-1 then notifies the terminal device 200 of the connection setting for performing the communication by DC (step S207).

Upon receiving this notification, the terminal device 200 transmits a NAS message requesting a service to the core network 10 (step S208), the core network 10 replies with a response to the request, and the base station device 100-1 notifies the terminal device 200 of the connection setting (step S209).

Thus, the connection for DC between the terminal device 200 and the base station devices 100-1 and 100-2 is completed and the wireless communication is performed between the terminal device 200 and the base station device 100-1, which is the primary base station (step S210), and additionally, the wireless communication is performed between the terminal device 200 and the base station device 100-1 via the base station device 100-2, which is the secondary base station (step S211). In other words, the communication by DC is performed between the terminal device 200 and the base station devices 100-1 and 100-2.

As described above, according to this embodiment, the terminal device selects the primary base station and the secondary base station in the non-communication mode and receives the notification of the UE context from the primary base station and the secondary base station. When the terminal device transits to the communication mode and performs the communication with the base station device, the communication with the primary base station and the secondary base station selected in the non-communication mode is started. Therefore, when the terminal device transits to the communication mode, there is no need to select the primary base station and the secondary base station by measuring the RSRP, and the delay in communication using the carriers can be suppressed.

### c. Third Embodiment

In a third embodiment, the primary base station selects the secondary base station by acquiring the results of RSRP measurement (IDLE mode measurement) by the terminal device in the RRC idle mode. The structure of the wireless communication system in the third embodiment is similar to that in the first embodiment (FIG. 1); thus, the description thereof is omitted. The structure of the base station device 100 and the terminal device 200 in the third embodiment is similar to that in the second embodiment (FIG. 2, FIG. 3); thus, the description thereof is omitted.

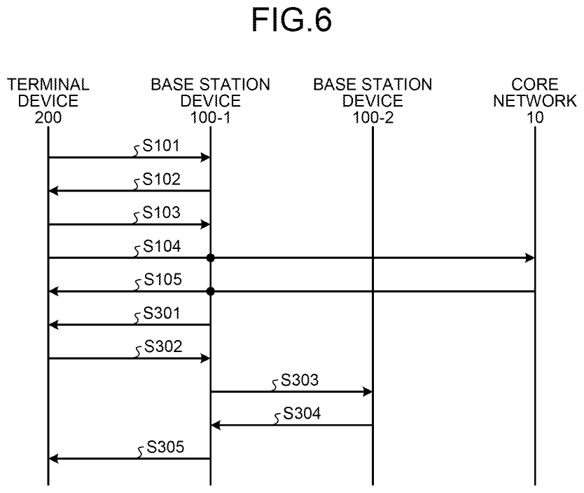

FIG. 6 is a sequence diagram illustrating a wireless transmission method in the wireless communication system according to the third embodiment. In FIG. 6, the same parts as those in FIG. 4 are denoted by the same symbols. In the following description, it is assumed that the wireless communication system includes the base station devices 100-1 and 100-2, whose structure is equivalent to that of the base station device 100.

The terminal device 200 measures the RSRP from the surrounding base station devices including the base station devices 100-1 and 100-2 in the non-communication mode and selects the primary base station. Here, it is assumed that the terminal device 200 has selected the base station device 100-1 with the highest RSRP, for example, as the primary base station.

Then, in the non-communication mode, the terminal device 200 transmits an AS message requesting the connection in order to establish the communication with the base station device 100-1, which is the primary base station (step S101). Examples of this AS message include an RRC connection request (Connection Request) and an RRC connection resume request (Connection Resume Request).

In response to this AS message, an AS message for a predetermined setting is transmitted from the base station device 100-1 to the terminal device 200 (step S102), and an AS message notifying the completion of the connection is transmitted from the terminal device 200 to the base station device 100-1 (step S103). The AS message notifying the completion of the connection can include information indicating that the base station device 100-1 is the primary base station, as well as flag information indicating that the RSRP is measured while the terminal device 200 is in the RRC idle mode. In other words, the terminal device 200 can notify the base station device 100-1 that the base station device 100-1 is selected as the primary base station, and also notify the base station device 100-1 that the terminal device 200 is the terminal device corresponding to IDLE mode measurement. Upon receiving this notification, the base station device 100-1 can grasp that the base station device 100-1 is the primary base station and that a secondary base station will be added. The information indicating that the base station device 100-1 is the primary base station and the flag information may be included in the AS message requesting the connection at step S101.

Once the connection between the terminal device 200 and the base station device 100-1 is established, a NAS message for registration is transmitted from the terminal device 200 to the core network 10 via the base station device 100-1 (step S104). When the terminal device 200 is registered in the core network 10, a NAS message indicating that the registration has been accepted is transmitted from the core network 10 to the terminal device 200 via the base station device 100-1 (step S105).

The base station device 100-1, having grasped that the base station device 100-1 is the primary base station, then requests the terminal device 200 to report the measurement result of the RSRP by IDLE mode measurement (step S301). Upon receiving this request, the terminal device 200 reports the measurement result of the RSRP measured in the RRC idle mode to the base station device 100-1 (step S302). This measurement result of the RSRP includes the measurement result of the RSRP from the base station devices surrounding the terminal device 200, including the base station device 100-2.

The base station device 100-1 selects the secondary base station according to the measurement result of the RSRP. Specifically, the base station device 100-1 selects, as the secondary base station, the base station device whose RSRP at the terminal device 200 is at or above a predetermined threshold. Here, it is assumed that the base station device 100-2 is selected as the secondary base station. After the secondary base station is selected, the base station device 100-1 requests the base station device 100-2, which is the secondary base station, to generate the UE context to be allocated to the terminal device 200 (step S303). Upon receiving this request, the base station device 100-2 generates the UE context for the terminal device 200 and notifies the identification information about the generated UE context to the base station device 100-1 (step S304).

On the other hand, the UE context about the terminal device 200 is also generated at the base station device 100-1. Temporary identification information including the identification information of the terminal device 200 and the identification information of the base station device 100-1 is then generated as the identification information of the UE context. This temporary identification information can be, for example, an inactive-radio network temporary identifier (I-RNTI). The I-RNTI is 40-bit identification information that can simultaneously identify the terminal devices and the base station devices. Since the I-RNTI is 40-bit identification information, allocating more bits to the identification information of the base station devices can identify more base station devices but can identify fewer terminal devices. If the number of bits allocated to the identification information of the base station devices is reduced, fewer base station devices can be identified while more terminal devices can be identified. Any information other than I-RNTI that can identify the UE context can be used as the identification information of the UE context.

The generated UE context is held by the base station device 100-1 and the information about the UE context is notified to the terminal device 200, for example, by an AS message to release the connection (step S305). Here, the information about the UE context generated by the base station device 100-1 is notified to the terminal device 200 together with the information about the UE context notified from the base station device 100-2. In other words, the information about the UE context generated by each of the base station devices 100-1 and 100-2 with respect to the terminal device 200 is notified to the terminal device 200 collectively. Upon receiving this notification, the terminal device 200 holds the information about the UE context and releases the connection with the base station device 100-1. At this time, the terminal device 200 may transit to the RRC inactive mode, for example.

Thus, in the non-communication mode, the terminal device 200 selects the primary base station according to RSRP and requests the connection, and the primary base station selects the secondary base station after acquiring the measurement result of the RSRP from the terminal device 200. The primary base station then acquires the information about the UE context from the secondary base station and notifies the terminal device 200 of the information about the UE context generated by each of the primary base station and the secondary base station. Therefore, when the terminal device 200 returns to the communication mode, the communication by DC with the primary base station and the secondary base station can be immediately performed. In other words, in a manner similar to the second embodiment (FIG. 5), when the terminal device 200 transits from the non-communication mode to the communication mode, there is no need to select the primary base station and the secondary base station by measuring the RSRP, and the delay in communication using the carriers can be suppressed.

As described above, according to this embodiment, when the terminal device selects the primary base station in the non-communication mode, the primary base station selects the secondary base station and notifies the terminal device of the information about the UE context generated by the primary base station and the secondary base station. When the terminal device transits to the communication mode and performs the communication with the base station device, the communication with the primary base station and the secondary base station selected in the non-communication mode is started. Therefore, when the terminal device transits to the communication mode, there is no need to select the primary base station and the secondary base station by measuring the RSRP, and the delay in communication using the carriers can be suppressed.

In each of the above embodiments, the secondary base station is only the base station device 100-2; however, more than one base station device may be selected as the secondary base stations. That is to say, for example, in the second embodiment, the terminal device 200 may select the secondary base stations in the non-communication mode, transmit AS messages requesting the connection to the respective secondary base stations, and receive the UE context notification from each secondary base station.

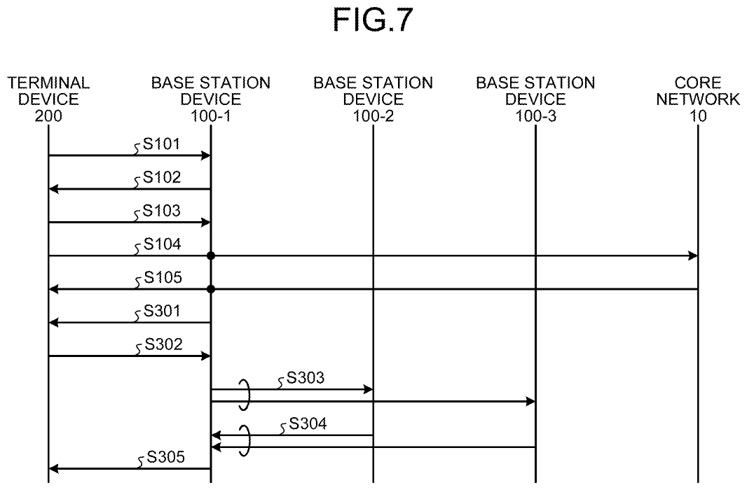

For example, in the third embodiment, as illustrated in FIG. 7, the base station devices 100-2 and 100-3 may be selected as the secondary base stations. As illustrated in FIG. 7, the base station device 100-1, which is the primary base station, selects the base station devices 100-1 and 100-2 as the secondary base stations according to the RSRP at the terminal device 200, and then requests these secondary base stations to generate the UE context to be allocated to the terminal device 200 (step S303). Upon receiving this request, each of the base station devices 100-2 and 100-3 generates the UE context and notifies the information about the generated UE context to the base station device 100-1 (step S304).

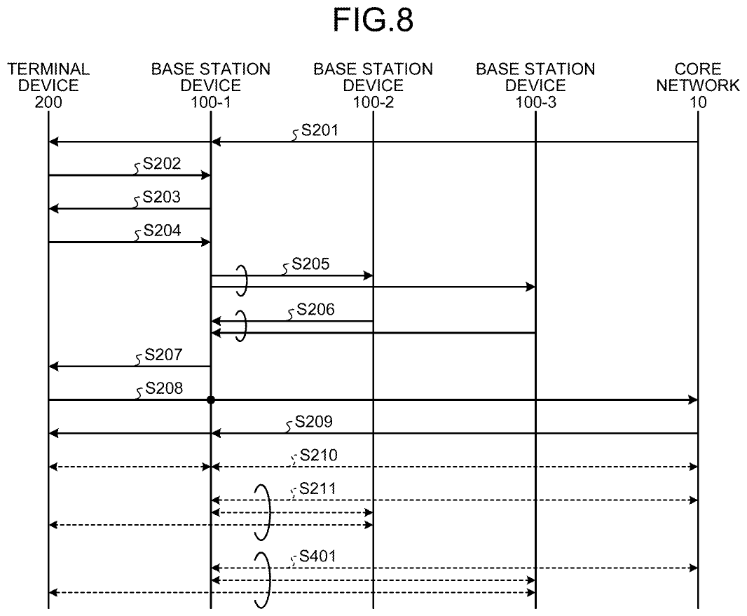

Thus, by using the base station devices as the secondary base stations, the terminal device 200 can perform the communication using the cells of the primary base station and the secondary base stations at the transition to the communication mode. FIG. 8 is a sequence diagram expressing the operation of the wireless communication system when the terminal device 200 transits from the non-communication mode to the communication mode. In FIG. 8, the same parts as those in FIG. 5 are denoted by the same symbols. Here, it is assumed that the base station device 100-1 is selected as the primary base station and the base station devices 100-2 and 100-3 are selected as the secondary base stations.

For example, when downlink data addressed to the terminal device 200 is generated, paging is performed to call the terminal device 200 from the core network 10 via the base station device 100-1, which is the primary base station (step S201). Upon receiving paging, the terminal device 200 transmits an AS message requesting the connection to the base station device 100-1 in order to return to the communication mode (step S202). This AS message is, for example, an RRC connection resume request (Connection Resume Request).

In response to this AS message, an AS message for a predetermined setting is transmitted from the base station device 100-1 to the terminal device 200 (step S203), and an AS message notifying the completion of the connection is transmitted from the terminal device 200 to the base station device 100-1 (step S204). The AS message notifying the completion of the connection includes identification information specifying the base station devices 100-2 and 100-3, which are the secondary base stations. This identification information can be, for example, the information about the UE context generated by each of the base station devices 100-2 and 100-3 with respect to the terminal device 200.

When the base station device 100-1 is notified of the identification information specifying the base station devices 100-2 and 100-3, which are the secondary base stations, the base station device 100-1 notifies the base station devices 100-2 and 100-3 that communication with the terminal device 200 by multiple access is performed (step S205). The base station devices 100-2 and 100-3 have grasped that the base station devices 100-2 and 100-3 are the secondary base stations and have specified the base station device 100-1, which is the primary base station. Therefore, the base station devices 100-2 and 100-3 reply a message to the base station device 100-1, saying that performing the communication by multiple access has been confirmed (step S206). The base station device 100-1 then notifies the terminal device 200 of the connection configuration for performing the communication by multiple access (step S207).

Upon receiving this notification, the terminal device 200 transmits a NAS message requesting a service to the core network 10 (step S208), the core network 10 replies with a response to the request, and the base station device 100-1 notifies the terminal device 200 of the connection configuration (step S209).

Thus, the setting for the multiple access between the terminal device 200 and the base station devices 100-1 to 100-3 is completed and the wireless communication is performed between the terminal device 200 and the base station device 100-1, which is the primary base station (step S210), and additionally, the wireless communication is performed between the terminal device 200 and the base station device 100-1 via the base station devices 100-2 and 100-3, which are the secondary base stations (steps S211 and S401). In other words, the communication by multiple access is performed between the terminal device 200 and the base station devices 100-1 to 100-3.

Thus, even in the case where the base station devices are selected as the secondary base stations, when the terminal device 200 transits to the communication mode, there is no need to select the base station to become the primary access and the secondary base station by measuring the RSRP, and the delay in communication using the carriers can be suppressed.

In each of the above embodiments, the terminal device 200 is connected to the base station devices 100-1 and 100-2 mainly by dual connectivity (DC); however, the communication method in each of the above embodiments is also applicable to carrier aggregation (CA) using the carriers. In other words, in each of the above embodiments, the base station devices 100-1 and 100-2 are described as separate entities forming the respective cells; however, the communication method similar to that in each of the above embodiments can be applied even when one base station device forms a primary cell and a secondary cell.

According to one aspect of the wireless communication device, the wireless communication system, and the wireless communication method disclosed herein, the effect is obtained in which the delay in communication using the carriers can be suppressed.

All examples and conditional language recited herein are intended for pedagogical purposes of aiding the reader in understanding the disclosure and the concepts contributed by the inventors to further the art, and are not to be construed as limitations to such specifically recited examples and conditions, nor does the organization of such examples in the specification relate to a showing of the superiority and inferiority of the disclosure. Although the embodiments of the present disclosure have been described in detail, it should be understood that the various changes, substitutions, and alterations could be made hereto without departing from the spirit and scope of the disclosure.

What is claimed is:

1. A wireless communication device comprising:
processor circuitry configured to control, in a case of performing communication with another wireless communication device, so as to perform data communication using simultaneously a plurality of cell groups including a cell being able to control a control plane and another cell that are selected when the communication with the other wireless communication device in a non-communication mode is established.

2. The wireless communication device according to claim 1, wherein upon acquisition of identification information about a secondary base station corresponding to the other cell from the other wireless communication device, the processor circuitry is further configured to notify the secondary base station that the data communication is performed.

3. The wireless communication device according to claim 1, wherein when the communication with the other wireless communication device in the non-communication mode is established, the processor circuitry is further configured to notify the other wireless communication device of identification information that is capable of identifying the wireless communication device and the other wireless communication device simultaneously.

4. The wireless communication device according to claim 1, wherein when the communication with the other wireless communication device in the non-communication mode is established, the processor circuitry is further configured to acquire a measurement result of reference signal received power in the other wireless communication device, determines a secondary base station corresponding to the other cell in accordance with the measurement result, and request the identification information to be allocated to the other wireless communication device from the secondary base station.

5. A wireless communication device comprising processor circuitry configured to control, in a case of performing communication with another wireless communication device, so as to perform data communication using simultaneously a plurality of cell groups including a cell being able to control a control plane and another cell that are selected when the communication with the other wireless communication device is established in a non-communication mode under control from the other wireless communication device.

6. The wireless communication device according to claim 5, wherein the processor circuitry is further configured to notify identification information about a secondary base station corresponding to the other cell to a primary base station corresponding to the cell capable of controlling the control plane.

7. The wireless communication device according to claim 5, wherein when the communication with the other wireless communication device is established in the non-communication mode, the processor circuitry is notified of identification information that is capable of identifying the wireless communication device and the other wireless communication device simultaneously from the other wireless communication device.

8. The wireless communication device according to claim 5, wherein when the communication with the other wireless communication device is established in the non-communication mode, the processor circuitry is further configured to notify information indicating that the other wireless communication device is a primary base station corresponding to the cell capable of controlling the control plane or information indicating that the other wireless communication device is a secondary base station corresponding to the other cell.

9. A wireless communication system comprising a first wireless communication device and a second wireless communication device, wherein
the first wireless communication device is further configured to control, in a case of performing communication with the second wireless communication device, so as to perform data communication using simultaneously a plurality of cell groups including a cell being able to control a control plane and another cell that are selected when the communication with the second wireless communication device in a non-communication mode is established, and
the second wireless communication device is further configured to control, in a case of performing communication with the first wireless communication device, so as to perform data communication using simultaneously the plurality of cell groups selected when the communication with the first wireless communication device is established in the non-communication mode under control from the first wireless communication device.
